(19) United States
(12) Patent Application Publication
(10) Pub. No.: US 2026/0226777 A1
(43) Pub. Date: Aug. 6, 2026

(54) MULTIPOINT LOCK SYSTEM WITH COUPLER

(71) Applicant: Amesbury Industries, Inc., Edina, MN (US)

(72) Inventor: Chris Allison, Irving, TX (US)

(73) Assignee: Amesbury Industries, Inc., Edina, MN (US)

(21) Appl. No.: 19/461,872

(22) Filed: Jan. 28, 2026

Related U.S. Application Data
(60) Provisional application No. 63/753,529, filed on Feb. 4, 2025.

(51) Int. Cl. E05C 9/20

(52) U.S. Cl. CPC E05C 9/20

(57) ABSTRACT

A coupler for a multipoint lock system includes a male adapter having with a first hook and end configured to attach to a drive rod of a remote lock point of the multipoint lock system. The coupler also includes a female adapter configured to receive at least a portion of the first hook. The female adapter including a U-shaped housing configured to attach to a slider bar of a central lock assembly of the multipoint lock system. A hook arm is pivotably mounted to the U-shaped housing and includes a second hook. Upon axial insertion of the male adapter into the female adapter, the first and second hooks engage, and a safety screw is configured to secure the pivoting position of the hook arm relative to the U-shaped housing.

### CROSS-REFERENCE TO RELATED APPLICATION(S

This application claims priority to, and the benefit of, U.S. Provisional Patent Application No. 63/753,529, filed February 4, 2025, the disclosure of which is hereby incorporated by reference in its entirety.

### INTRODUCTION

Multipoint lock systems generally have a plurality of locking points at spaced locations on a door. A central lock assembly can support a handle and a central retracting latch or bolt for locking. Additionally, one or more remote lock points may be coupled to the central lock assembly and include one or more remote latches or bolts for locking. The remote lock points are typically at least partially operated through the central lock assembly via movement of a drive bar or rod extending therebetween. These latches or bolts from the central lock assembly and the remote lock points are located in the edge of the door and extend horizontally into the door jamb and/or vertically into the head and/or sill of the door. Multipoint lock systems utilizing locking elements that extend into keepers on two or more planes (e.g., into a jamb, a sill, and/or a header) are more effective at securing a door than locks that extend into a single keeper on a single plane. However, attaching the central lock assembly to the drive bar or rods during installation and/or service can be difficult because of a mortised mount on the door and the door being hung on the door frame.

### SUMMARY

In an aspect, the technology relates to a coupler for a multipoint lock system including: a male adapter having a first end having a first hook and an opposite second end configured to attach to a drive rod of a remote lock point of the multipoint lock system; and a female adapter including: a U-shaped housing with a first end configured to attach to a slider bar of a central lock assembly of the multipoint lock system and an opposite second end configured to receive the first hook of the male adapter; a hook arm pivotably mounted to the U-shaped housing, the hook arm including a second hook disposed at the second end of the U-shaped housing; a safety screw mounted to the hook arm and positioned at the first end of the U-shaped housing; and a biasing member biasing a pivoting position of the hook arm, wherein upon axial insertion of the male adapter into the female adapter, the first and second hooks engage and the safety screw is configured to secure the pivoting position of the hook arm relative to the U-shaped housing, and wherein the biasing member biases the hook arm towards an engaged configuration

In an example, the second hook is disposed on one end of the hook arm and a threaded aperture for the safety screw is disposed on an opposite end of the hook arm, and the hook arm is coupled to a pivot pin extending across the U-shaped housing, the pivot pin disposed between the second hook and the threaded aperture. In another example, the U-shaped housing includes a cross-wall disposed between the first and second ends of the U-shaped housing, the cross-wall defining an axial end of a receiving chamber for the first hook of the male adapter within the female adapter. In yet another example, the hook arm is pivotably mounted to the U-shaped housing with a pivot pin, the pivot pin disposed between the first end of the U-shaped housing and the cross-wall. In still another example, the first end of the U-shaped housing includes a stop for the safety screw. In an example, a thickness of the first hook is greater than a thickness of the second hook.

In another aspect, the technology relates to a multipoint lock system including: a central lock assembly having a deadbolt configured to extend and retract along a transverse axis relative to a housing, wherein a slider bar is disposed at least partially within the housing and configured to slide along a longitudinal axis orthogonal relative to the transverse axis; a remote lock point operable via a drive rod, movable along the longitudinal axis, via the slider bar of the central lock assembly; and a coupler including: a first adapter having a first hook configured to couple to the drive rod of the remote lock point or the slider bar of the central lock assembly; and a second adapter configured to couple to the other of the drive rod of the remote lock point or the slider bar of the central lock assembly, the second adapter including: a U-shaped housing; a second hook pivotably mounted to the U-shaped housing, wherein the second hook is biased in a direction towards a base wall of the U-shaped housing, and wherein upon axial insertion of the first hook into the U-shaped housing along the longitudinal axis, the first and second hooks engage operationally connecting the drive rod and the slider bar for movement along the longitudinal axis

In an example, the multipoint lock system further includes a safety screw coupled to the second adapter and locking the engagement between the first and second hooks. In another example, the housing of the central lock assembly defines at least one longitudinal axis opening and at least one transverse axis opening, and the safety screw is accessible through the at least one transverse axis opening. In yet another example, a base of the U-shaped housing is opposite of the at least one transverse axis opening such that the second hook faces the at least one transverse axis opening. In still another example, the second adapter is coupled to the slider bar of the central lock assembly, and when the slider bar is disposed in a retracted position within the housing, the second adapter is completely disposed within the housing. In an example, the first adapter is coupled to the drive rod of the remote lock point.

In another example, the first hook is radially offset from a center axis of a cylindrical portion configured to couple to the drive rod. In yet another example, the U-shaped housing includes a first end and an opposite second end, a cross-wall is disposed between the first and second ends, the cross-wall defining an axial stop for receipt of the first hook. In still another example, a pivot point for the second hook is disposed between the first end of the U-shaped housing and the cross-wall. In an example, the first hook has a thickness that is greater than a thickness of the second hook. In another example, the first hook includes a rounded nose, an oblique surface extending from the rounded nose, and a planar return extending in the transverse axis direction, and adjacent to the planar return, the first hook includes a recess configured to engage with a portion of the second hook.

In another aspect, the technology relates to a method of assembling a multipoint lock system including: providing a central lock assembly having a slider bar disposed at least partially within a housing and configured to slide along a longitudinal axis, the slider bar coupled to a female adapter having a U-shaped housing and a first hook pivotably mounted to the U-shaped housing; providing a remote lock point having a drive rod movable along the longitudinal axis, the drive rod coupled to a male adapter having a second hook; moving the second hook of the male adapter with the drive rod along the longitudinal axis; receiving the second hook of the male adapter within a distal end of the female adapter and engaging the second hook with the first hook of the female adapter, wherein receiving the second hook of the male adapter overcomes a biased position of the first hook; and securing the engagement between the first and second hooks with a safety screw.

In an example, the female adapter is disposed completely within the housing of the central lock assembly when receiving the male adapter. In another example, the central lock assembly and the remote lock point are mortised within an edge of a door.

### BRIEF DESCRIPTION OF THE DRAWINGS

There are shown in the drawings, examples that are presently preferred, it being understood, however, that the technology is not limited to the precise arrangements and instrumentalities shown.

FIG. 1 is a perspective view of a multipoint lock system having a coupler in an extended position relative to a central lock assembly.

FIG. 2 is a perspective view of the multipoint lock system having the coupler in a retracted position relative to the central lock assembly.

FIGS. 3 and 4 are perspective views of a male adapter of the coupler.

FIG. 5 is an exploded perspective view of a female adapter of the coupler.

FIG. 6 is a perspective view of a housing of the female adapter shown in FIG. 5.

FIG. 7 is a perspective view of a hook arm of the female adapter shown in FIG. 5.

FIG. 8 is a cross-sectional view of the female adapter.

FIG. 9 is a cross-sectional view of the coupler in an engaged configuration.

FIG. 10 is a cross-sectional view of the coupler with a safety screw loosened.

FIG. 11 is a cross-sectional view of the coupler with the safety screw loosened and the hook arm pivoted.

FIG. 12 is a cross-sectional view of the coupler with the hooks axially moved relative to each other.

FIG. 13 is a cross-sectional view of the coupler in a disengaged configuration.

FIG. 14 is a flowchart illustrating an exemplary method of assembling a multipoint lock system.

FIGS. 15 and 16 are perspective views of another exemplary coupler in accordance with the principles described herein.

### DETAILED DESCRIPTION

A coupler for a multipoint lock system is described below and includes a female adapter that attaches to a slider bar of a central lock assembly and a male adapter that attaches to a drive rod of a remote lock point. Each of the female and male adapters have corresponding hooks configured to engage and operationally couple the drive rod with the slider bar. The female adapter includes a locking mechanism to prevent undesirable disengagement with the male adapter. The female adapter also at least partially surrounds a hook engagement area so as to prevent transverse disengagement of the hooks. The coupler is accessible from a front face of the multipoint lock system so that the slider bar of the central lock assembly and the drive rod of the remote lock point can be easily separated from each other without first removing a door from the door frame.

In most known multipoint lock systems, concealed gearboxes (e.g., central lock assembly) cannot be removed from the door while the door is attached to the frame. In some known multipoint lock systems with vertically extending shoot bolts as the remote lock point, the shoot bolts need to be in an extended position in order to separate the drive rod from the slider bar because of the configuration of the central lock assembly and the coupling area needing to be disposed outside of the central lock assembly. As such, field service and/or replacement is more difficult and time consuming because the door is needed to be removed from the frame. With the coupler described herein the coupler is accessible and operable while still being at least partially within the central lock assembly. As such, once the remote lock point or points are disconnected from the central lock assembly, the central lock assembly can be removed from the door without removal of the door from the door frame. This configuration facilitates easier field service of faulty and/or damaged locks and without modification to existing door fabrication. The coupler also facilitates easier initial lock installation within the door. Additionally, the coupler configuration may be utilized in other door lock hardware connections as required or desired. For example, but not limited to, coupling two modular drive rods together for operation of the remote lock point, coupling the drive rod to the remote lock point, and the like

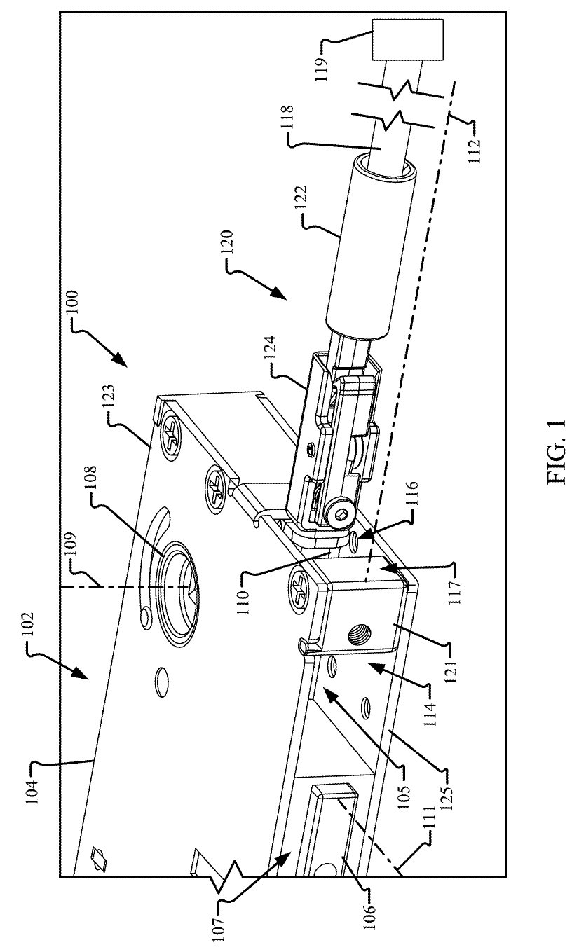

FIG. 1 is a perspective view of a multipoint lock system 100. The multipoint lock system 100 includes a central lock assembly 102 configured to be mortised within an edge of a door (not shown). The central lock assembly 102 includes a housing 104, also known as a gear box, which houses a drive system 105 therein and configured to selectively extend and retract a dead bolt 106 from a front face 107 of the housing 104. For example, a rotatable cam 108 is supported on a side of the housing 104 and rotatable around a rotation axis 109. The cam 108 is configured to receive a torque blade from a handle, thumbturn, key cylinder, or the like. Upon rotation of the cam 108 via the torque blade, the dead bolt 106 may extend and retract along a transverse axis 111 and relative to the front face 107. The transverse axis 111 is orthogonal to the rotation axis 109 of the cam 108. The drive system 105 that facilitates actuation of the dead bolt 106 may take on any configuration currently known or developed in the future.

While the central lock assembly is described as having a deadbolt lock configuration, it is appreciated that the central lock assembly can additionally, or alternatively, have any other lock assembly configuration as required or desired. For example, the central lock assembly may include a latch bolt that is configured to extend and retract relative to the front face of the housing and also automatically retract via contact with a keeper and swinging closing of the door. In other examples, the central lock assembly may include one or more hook bolts configured for sliding door use

In the example, the drive system 105 of the central lock assembly 102 includes at least one slider bar 110 that is configured to slide in a direction substantially parallel to a longitudinal axis 112 of the housing 104. The longitudinal axis 112 is orthogonal to both the rotation axis 109 and the transverse axis 111. The movement of the slider bar 110 may be coupled to the movement of the dead bolt 106, or in other examples, the movement of the slider bar 110 may be independent from the movement of the dead bolt 106 (e.g., via additional movement of the handle, thumbturn, key cylinder, or the like). The housing 104 includes one or more openings 114, 116 that allow for access to at least a portion of the slider bar 110. The opening 114 may be located at the front face 107 of the housing 104 and open along the transverse axis 111. The opening 116 may be located at a longitudinal end face 117 of the housing 104 and open along the longitudinal axis 112.

In the example, the longitudinal end face 117 may be a top end of the housing 104 and that extends upward in a vertical direction when mounted on the door. Accordingly, the slider bar 110 is configured to drive operation of a remote lock point 119 (shown schematically) positioned above central lock assembly 102 and via a drive rod 118 extending therebetween. The remote lock point 119 may be a shoot bolt type lock that extends from a top edge of the door and that extends and retracts along the vertical direction along the longitudinal axis 112. In other examples, the remote lock point may extend from the same edge of the door as the central lock assembly 102 and have a bolt or latch or hook that extends and retracts either linearly or pivotably and driven via movement of the slider bar 110.

In other examples, the longitudinal end face 117 may be a bottom end of the housing 104 and that extends downward in the vertical direction when mounted on the door. The housing 104 may also include an opening at a bottom end of the housing 104 (not shown) and so that a lower remote lock point is operated via the central lock assembly 102. In this example, the remote lock point may be a shoot bolt type lock that extends from a bottom edge of the door. The central lock assembly 102 may include a separate slider bar for operation of the lower remote lock point and that couples to a lower drive rod. In still other examples, the central lock assembly 102 may include both upper and lower remote lock points as required or desired. The slider bar 110 may be coupled to both the upper and lower drive rods as required or desired or there may be different slider bars for the upper and lower drive rods.

A coupler 120 is provided to connect the slider bar 110 to the drive rod 118 and transfer linear movement therebetween along the longitudinal axis 112. As illustrated in FIG. 1, the coupler 120 is in an extended position relative to the housing 104 and that corresponds to a locked configuration of the remote lock point 119. In the extended position of the coupler 120, a distal end of the slider bar 110 is disposed at the opening 116 at the longitudinal end face 117 of the housing 104, and the drive rod 118 is in the extended most position away from the housing 104. When the slider bar 110 and the drive rod 118 are extended, the connection between the slider bar 110 and the drive rod 118 is made easier as the connection location is positioned outside of the housing 104, and for example, during initial door hardware installation. However, the drive rod 118 may not always be able to be extended while the door is hung on the frame, and for example, lower shoot bolts cannot be extended through a lower floor.

In known multipoint systems, the door is first removed from the frame to perform field service or replace the multipoint system or portions thereof. The coupler 120 facilitates an assembly system that can be manipulated from the front face 107 of the multipoint lock system 100 and that allows the drive rod 118 to be disconnected from the slider bar 110 of the central lock assembly 102 without needing fabrication changes to the door or door removal. Once the drive rod 118 is disconnected from the slider bar 110 of the central lock assembly 102, the central lock assembly 102 can be removed from the door without removing the remote lock point 119 or the door from the frame, thereby facilitating easier field service of the multipoint lock system 100

In the example, the coupler 120 includes a male adapter 122 connected to the drive rod 118 and a female adapter 124 connected to the slider bar 110. The male and female adapters 122, 124 are configured to releasably couple together and facilitate operation of the multipoint lock system 100 as described herein. Additionally, in the example, the housing 104 includes a corner support 121 that extends between two side plates 123, 125 of the housing 104. The corner support 121 may at least partially define the openings 114, 116 within the housing 104. By using the corner support 121, access to the coupler 120 is enabled. In an aspect, the corner support 121 is substantially rectangular in cross-sectional shape. A threaded aperture may be defined on the front face 107 of the corner support 121 so that a face plate (not shown) of the multipoint lock system 100 can be attached to the housing 104.

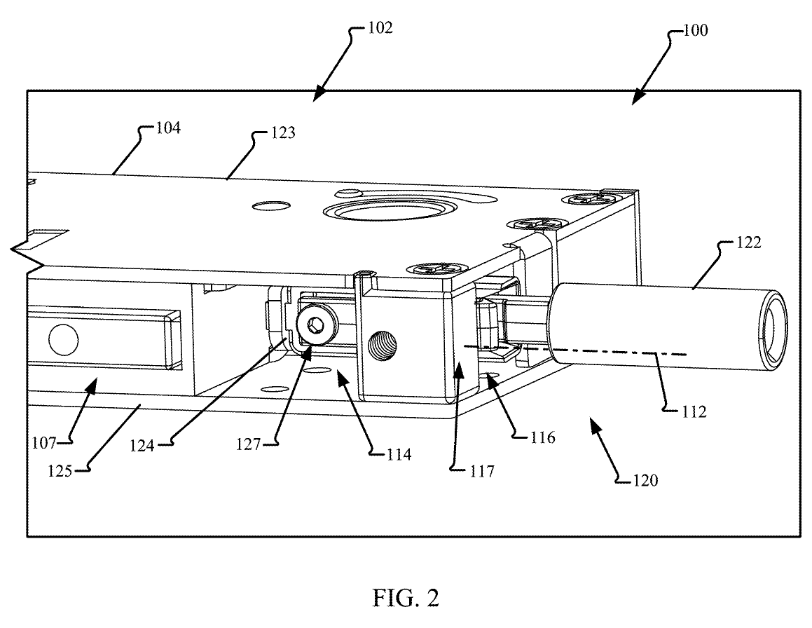

FIG. 2 is a perspective view of the multipoint lock system 100 having the coupler 120 in a retracted position relative to the central lock assembly 102. In the retracted position, the distal end of the slider bar 110 (shown in FIG. 1) is retracted within the housing 104 and along the longitudinal axis 112. With the slider bar 110 retracted, the coupler 120 is at least partially disposed within the housing 104 and extending through the opening 116. In the example, the female adapter 124 is disposed entirely within the opening 116 of the housing 104 and within the longitudinal end face 117. The male adapter 122 still projects and extends from the longitudinal end face 117 of the housing 104

The female adapter 124 is accessible via the opening 114 on the front face 107 of the housing 104 when the coupler 120 is retracted. For example, a locking mechanism 127 is accessible from the opening 114 so that the coupler 120 can be configured to be released when in the retracted position and with the male adapter 122 being withdrawn along the longitudinal axis 112. Allowing access through the housing 104 to the coupler 120 and with the configuration of the coupler 120 facing the front face 107 of the housing 104, connecting and disconnecting the remote lock point 119 (shown in FIG. 1) from the central lock assembly 102 is facilitated from the edge of the door.

In the example, the opening 114 is shaped and sized to facilitate transverse access into the housing 104 for the locking mechanism 127 and the female adapter 124. The opening 116 is shaped and sized to facilitate the female adapter 124 extending and retracting therethrough. The opening 116 may be smaller in size than the opening 114. One or both of the openings 114, 116 are defined by, and extend between, the side plates 123, 125 of the housing 104.

While the male adapter 122 is described as being configured to couple to the remote lock point 119 and the female adapter 124 is described as being configured to couple to the central lock assembly 102, it is appreciated that the male adapter 122 may couple to the central lock assembly 102 and the female adapter 124 may couple to the remote lock point 119 as required or desired. In this configuration, when the slider bar 110 is retracted, a portion of the female adapter 124 may still extend into the housing 104 and with transverse access provided. In still other examples, the rod of the remote lock point can connect to a modified version of the male adapter which can directly attach to the central lock assembly

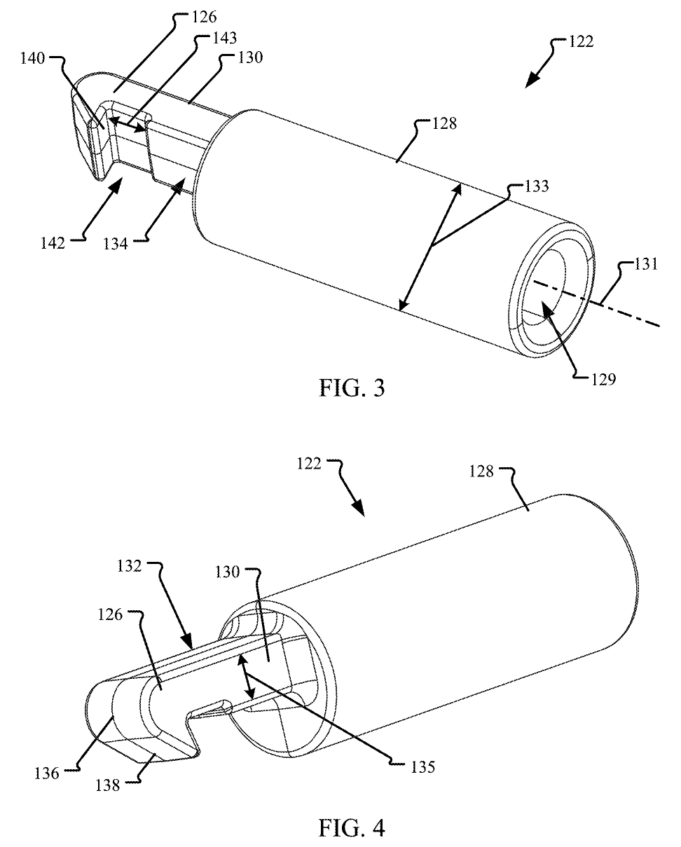

FIGS. 3 and 4 are perspective views of the male adapter 122 of the coupler 120 (shown in FIGS. 1 and 2). Referring concurrently to FIGS. 3 and 4, the male adapter 122 is elongated along the longitudinal axis 112 (shown in FIGS. 1 and 2) and includes a first end defining a first hook 126 (e.g., adapter hook) and an opposite second end defining a cylindrical portion 128.

The cylindrical portion 128 has an inner opening 129 extending along a central axis 131 with a threaded inner surface. The cylindrical portion 128 is configured to coaxially receive a portion of the drive rod 118 (shown in FIG. 1) and fixedly attach thereto. In an aspect, the drive rod 118 threadedly engages with the male adapter 122. In another aspect, the drive rod 118 may connect to the second end of the male adapter 122 via any other connection method as required or desired. The inner opening 129 may include a beveled surface that facilitates receipt of the drive rod 118 into the second end of the male adapter 122. The cylindrical portion 128 defines an outer diameter 133.

The first hook 126 of the male adapter 122 has an elongated body 130 that projects from the cylindrical portion 128 and with an outer surface 132 and an inner surface 134. The elongated body 130 has a rectangular cross-section shape with a thickness 135 defined between the outer and inner surfaces 132, 134. A distal end of the elongated body 130 defines the first hook 126 with a rounded nose 136 extending from the outer surface 132 and an inner oblique surface 138. In an aspect, the inner oblique surface 138 may be about 36° relative to the central axis 131. A planar return 140 extends inwardly from the inner oblique surface 138 to the inner surface 134. In an aspect, the planar return 140 may be angled about 74° relative to the central axis 131. The inner surface 134 includes a recess 142 adjacent the planar return 140 such that the thickness 135 of the elongated body 130 between the outer and inner surfaces 132, 134 is thinner at the recess 142. The recess 142 extends a longitudinal distance 143 that is about equal to the thickness 135 of the elongated body 130. The first hook 126 is radially offset from the central axis 131 of the cylindrical portion 128. As such, the inner surface 134 is radially closer to the central axis 131 than the outer surface 132

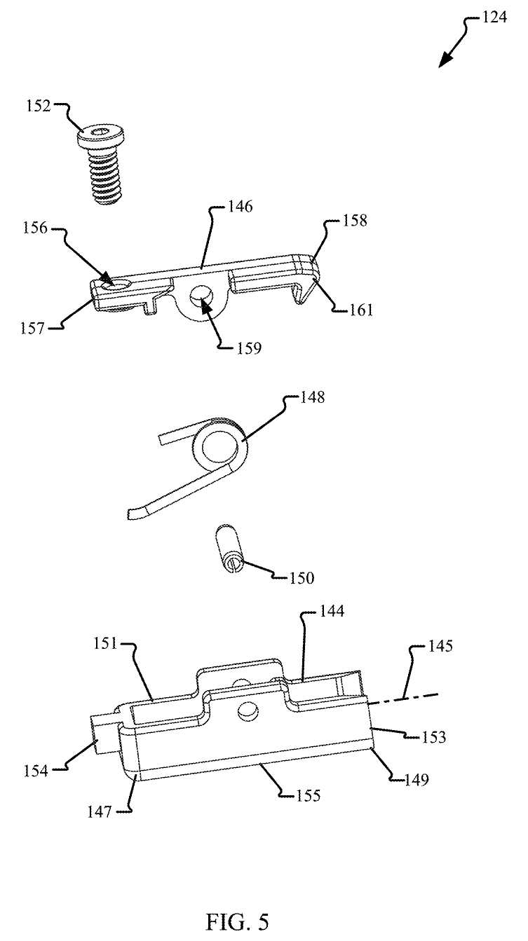

FIG. 5 is an exploded perspective view of the female adapter 124 of the coupler 120 (shown in FIGS. 1 and 2). The female adapter 124 includes a housing 144, a hook arm 146, a biasing member 148, a pivot pin 150, and a safety screw 152. The housing 144 has a substantially U-shaped cross-section elongated along a housing axis 145. The housing 144 is closed at a first end 147 and includes a projection 154 axially extending therefrom. The projection 154 is configured to fixedly attach to the distal end of the slider bar 110 (shown in FIG. 1). In the example, the projection 154 is substantially square in shape. A second end 149 of the housing 144 is open and configured to receive the first hook 126 of the male adapter 122 (shown in FIGS. 3 and 4). The U-shaped cross-section of the housing 144 is formed with a pair of sidewalls 151, 153 connected by a base wall 155.

The hook arm 146 is pivotably mounted between the two sidewalls 151, 153 of the housing 144 via the pivot pin 150 and opposite the base wall 155 of the housing 144. The pivot pin 150 extends orthogonally relative to the housing axis 145 and forms a pivot point for the hook arm 146. The hook arm 146 includes a first end 157 that is disposed proximate the projection 154 of the housing 144 and that supports the safety screw 152 via a threaded aperture 156. A second end 161 of the hook arm 146 defines a second hook 158 (e.g., receiver hook). A through hole 159 is defined between the first and second ends 157, 161 of the hook arm 146 and that receives the pivot pin 150 so that the hook arm 146 is pivotable relative to the housing 144. The pivot pin 150 is disposed between the second hook 158 and the threaded aperture 156 on the hook arm 146. The biasing member 148 is a torsion spring and is supported around the pivot pin 150 between the hook arm 146 and the housing 144. In the example, the biasing member 148 biases the second hook 158 in a direction towards the base wall 155 of the housing 144

In the example, the safety screw 152 forms the locking mechanism for the female adapter 124 along with the biasing of the hook arm 146 into engagement with the male adapter 122. Accordingly, the female adapter 124 captures the male adapter 122 and restricts or prevents transverse disengagement unless the locking mechanism is released and that can be accessed within the housing of the central lock assembly.

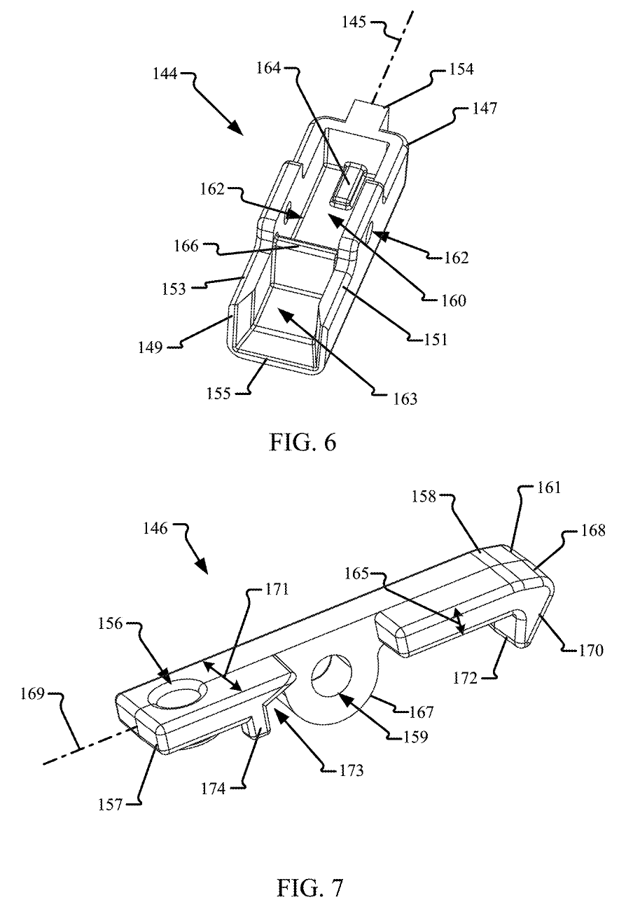

FIG. 6 is a perspective view of the housing 144 of the female adapter 124 (shown in FIG. 5). The housing 144 has a U-shaped cross-sectional profile with the two sidewalls 151, 153 and the base wall 155 extending along the housing axis 145 and defining an inner cavity 160. Each of the sidewalls 151, 153 has a projecting tab defining holes 162 that are configured to receive the pivot pin 150 (shown in FIG. 5) such that the pivot pin 150 is orthogonal relative to the housing axis 145. The first end 147 of the housing 144 is enclosed and includes the projection 154 extending therefrom. In the example, the projection 154 is offset relative to the base wall 155. The base wall 155 of the housing 144 includes a stop 164 positioned to engage with the safety screw 152 (shown in FIG. 5). The stop 164 projects within the inner cavity 160 and extends along the housing axis 145.

Additionally, a cross-wall 166 extends within the housing 144 proximate the second end 149 and the end that receives the male adapter 122 (shown in FIG. 3). The cross-wall 166 is orthogonal relative to the housing axis 145 and is disposed between the first and second ends 147, 149 of the housing 144. In the example, the cross-wall 166 is disposed between the holes 162 of the sidewalls 151, 153 and the second end 149 of the housing 144 such that the cross-wall 166 is disposed between the pivot pin 150 and the second end 149 of the housing 144. The cross-wall 166 defines an internal axial end and stop of a receiving chamber 163 of the inner cavity 160 of the housing 144 and that is configured to receive at least a portion of the male adapter 122 (e.g., the hooked end). The inner surfaces of the second end 149 of the housing 144 may also be beveled so as to facilitate insertion of the male adapter 122 into the receiving chamber 163 defined by the housing 144. The inner cavity 160 of the housing 144, between the cross-wall 166 and the first end 147 is sized and shaped to at least partially house the biasing member 148 (shown in FIG. 5

FIG. 7 is a perspective view of the hook arm 146 of the female adapter 124 (shown in FIG. 5). The hook arm 146 defines the second hook 158 at the second end 161. The second hook 158 includes a rounded nose 168, an outer oblique surface 170, and a planar return 172. The second hook 158 has a thickness 165 defined between outer and inner surfaces. In the example, the thickness 165 is less than the thickness 135 of the first hook 126 of the male adapter 122 (both shown in FIG. 4). The second hook 158 is configured to engage with the first hook 126 of the male adapter 122 as described herein.

The first end 157 of the hook arm 146 includes the threaded aperture 156 that receives the safety screw 152 (shown in FIG. 5) and so that the screw can extend through the hook arm 146 and lock position of the hook arm 146 within the female adapter 124. Disposed between the first and second ends 157, 161 the hook arm 146 includes a flange 167 that extends orthogonally relative to an axis 169 of the hook arm 146 and that defines the through hole 159 for receiving the pivot pin 150 (shown in FIG. 5). In the example, the flange 167 is about half of a width 171 of the hook arm 146 so that the biasing member 148 (shown in FIG. 5) can be mounted around the pivot pin 150. A shoulder 174 is disposed between the through hole 159 and the threaded aperture 156 and extends from an inner surface of the hook arm 146. The shoulder 174 facilitates alignment within the inner cavity 160 of the housing 144 (shown in FIG. 6) when the hook arm 146 is pivotably mounted thereto. Additionally, the shoulder 174 is configured to capture a portion of the biasing member 148 on an orthogonal surface 173 that at least a portion of the biasing member 148 engages with

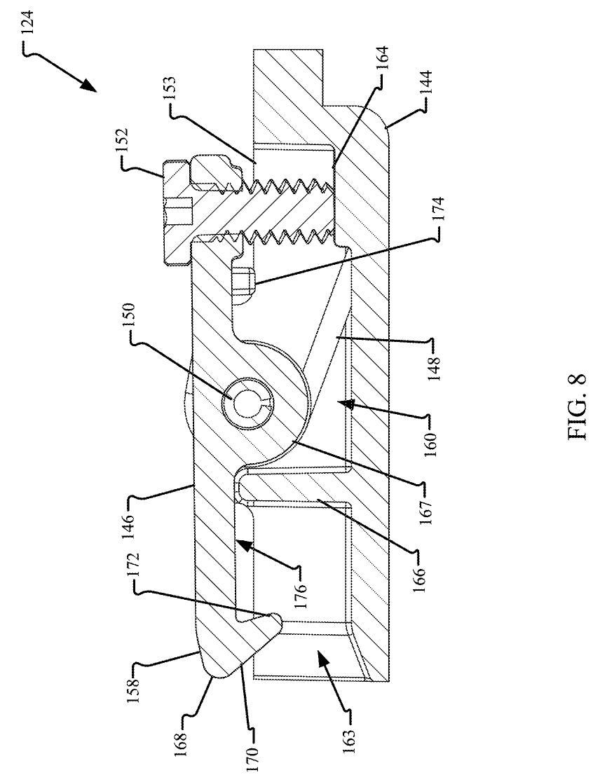

FIG. 8 is a cross-sectional view of the female adapter 124. In the example, the pivot pin 150 has a pivoting axis that is disposed above the sidewalls 153 of the housing 144. This positions an inner surface 176 of the hook arm 146 above the sidewalls 153 of the housing 144 and with the rounded nose 168 of the second hook 158 disposed above the sidewalls 153 of the housing 144. The outer oblique surface 170 and the planar return 172 of the second hook 158 may extend across the top of the sidewalls 153. This configuration of the female adapter 124 provides more space within the receiving chamber 163 to receive the first hook 126 of the male adapter 122 (shown in FIGS. 3 and 4) and with the first hook 126 having a greater thickness than the second hook 158.

The cross-wall 166 is positioned directly adjacent to the flange 167 of the hook arm 146 and restricts counterclockwise rotation of the hook arm 146 around the pivot pin 150 in the orientation illustrated in FIG. 8. The safety screw 152 is attached to the hook arm 146 and extends into the inner cavity 160 of the housing 144. The safety screw 152 is configured to engage with the stop 164 so as to lock rotational position of the hook arm 146 and restrict clockwise rotation of the hook arm 146 and to capture the first hook 126 within the receiving chamber 163.

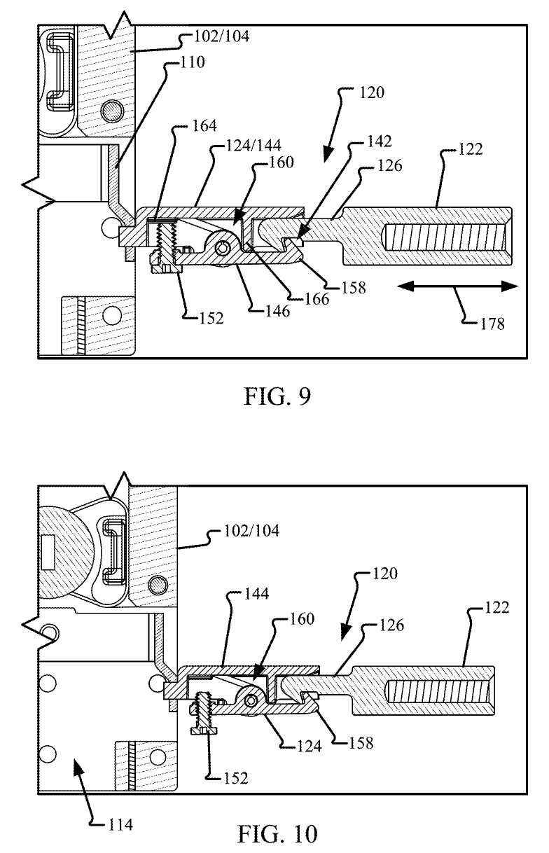

FIG. 9 is a cross-sectional view of the coupler 120 in an engaged configuration. In the engaged configuration, the first hook 126 of the male adapter 122 is received within the distal end of the female adapter 124 and engaged with the second hook 158. The safety screw 152 is positioned so that it extends into the inner cavity 160 of the housing 144 and close to or directly touching the stop 164. The safety screw 152 has a length such that the hook arm 146 is prevented from pivoting and disengaging with the male adapter 122. Additionally, the housing 144 of the female adapter 124 surrounds the first hook 126 on three sides so that transverse forces are prevented from disengaging the coupler 120 and from causing transverse movement of the first hook 126. In this engaged configuration, longitudinal movement 178 of the slider bar 110 is transferred through the coupler 120 and into the drive rod (not shown) and to facilitate operation of the attached remote lock point(s). The outside surfaces of the housing 144 and the hook arm 146 form a square or rectangle outer perimeter cross-sectional profile so that during longitudinal movement, the coupler 120 can easily slide into and out of the housing 104 of the central lock assembly 102.

In the example, the cross-wall 166 of the housing 144 defines an axial stop for the first hook 126 so that axial movement can be transferred between the male and female adapters 122, 124 in both directions along the longitudinal movement 178. For example, when the slider bar 110 is being retracted within the housing 104, the hooked ends of the first and second hooks 126, 158 are able to pull the drive rod towards the housing 104. When the slider bar 110 is being extended out of the housing 104, the cross-wall 166 of the housing 144 pushes the first hook 126 away and the attached drive rod away from the housing 104. The second hook 158 is also at least partially received within the recess 142 of the first hook 126 when in the engaged configuration.

FIG. 10 is a cross-sectional view of the coupler 120 with the safety screw 152 loosened. In order to disengage the coupler 120, the safety screw 152 is first loosened (e.g., rotated) and so that the safety screw 152 is pulled at least partially out of the inner cavity 160 of the housing 144. This position of the safety screw 152 allows the second hook 158 to pivot in a counterclockwise direction and away from the housing 144. The safety screw 152 moves in a transverse direction relative to the coupler 120 and access to the safety screw 152 is in a transverse direction. If the coupler 120 is disposed outside of the housing 104 of the central lock assembly 102, then the transverse access to the coupler 120 may be from outside of the housing 104. If the female adapter 124 is disposed within the housing 104, then the transverse access to the coupler 120 may be within the transverse opening 114 of the housing 104. Accordingly, the coupler 120 is operable in both extended and retracted positions relative to the housing 104 and so that the corresponding remote locks can be positioned as required or desired for installation and/or repair. While loosening the safety screw 152 is described as being performed for disengaging the coupler 120, the loosened position of the safety screw 152 also facilitates initially coupling the coupler 120 together because the second hook 158 is required to be pivoted in order to first engage the first hook 126.

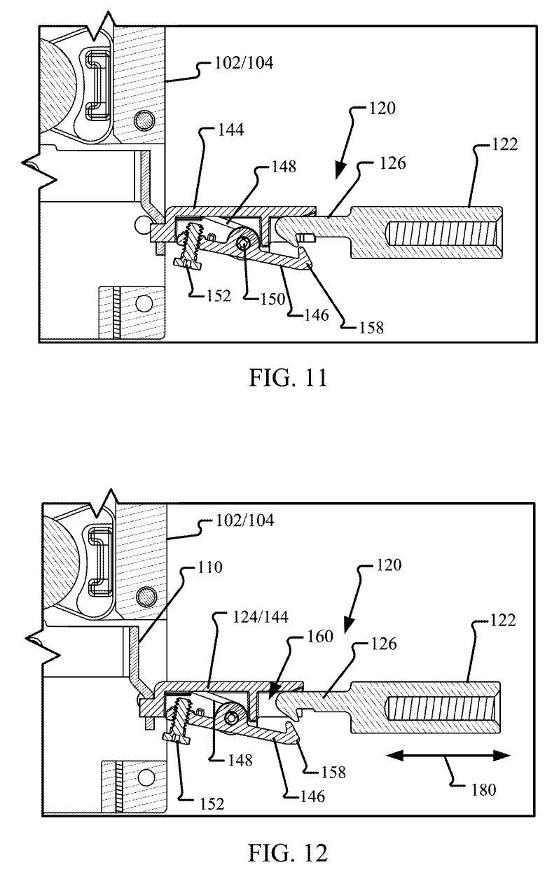

Turning to FIG. 11, once the safety screw 152 is loosened, the hook arm 146 may be depressed at the end that has the safety screw 152 such that the biasing member 148 is overcome and the safety screw 152 is at least partially moved into the housing 144. This pivoting movement of the hook arm 146 around the pivot pin 150 moves the second hook 158 out of the housing 144 and disengages the second hook 158 from the first hook 126 of the male adapter 122. In the example, the depression force at the hook arm 146 for pivoting is in the transverse direction and may be a manual force applied to the coupler 120 and for disengagement.

For engagement of the coupler 120, when the safety screw 152 is loosened, axial movement of the first hook 126 towards the second hook 158 can automatically pivot the hook arm 146 via sliding contact between the oblique surfaces of the hooks. As such, even if the female adapter 124 is disposed within the housing 104, the male adapter 122 can be blindly axially inserted into the female adapter 124.

Once the first and second hooks 126, 158 are disengaged, the hooks can axially move 180 relative to one another and as illustrated in FIG. 12. With the hooks disengaged, the slider bar 110 can be slightly retracted so as to move the female adapter 124 away from the male adapter 122 and move the hooks at least partially axially away from each other. Additionally, or alternatively, the male adapter 122 may be retracted in a direction away from the female adapter 124 to axially move the hooks away from each other. The biasing member 148 biases the hook arm 146 towards the engaged position and into the inner cavity 160 of the housing 144 so that the second hook 158 automatically moves back towards the housing 144 when the hook arm 146 is released. Similarly, for engagement of the coupler 120, the slider bar 110 and/or the drive bar may be axially moved together for receipt of the male adapter 122 within the female adapter 124. The biasing of the hook arm 146 will automatically capture the first hook 126 and until the safety screw 152 is used to secure the hook arm 146 into place.

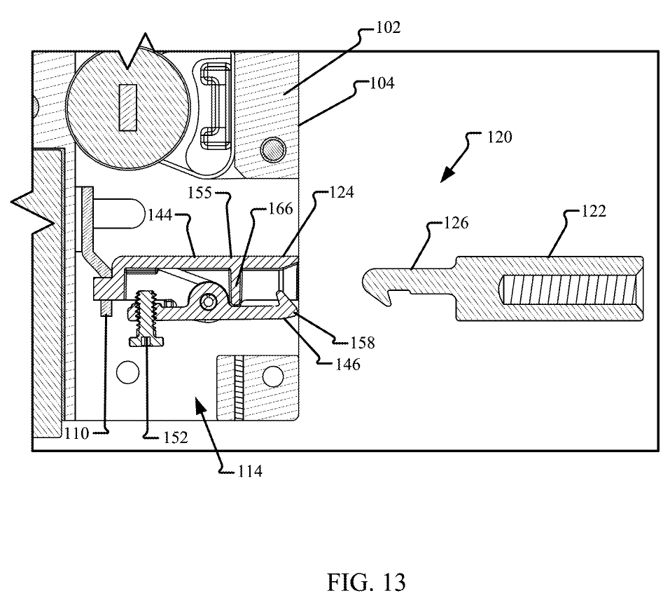

FIG. 13 is a cross-sectional view of the coupler 120 in a disengaged configuration. With the male adapter 122 disengaged from the female adapter 124, the slider bar 110 can be fully retracted so that the female adapter 124 is disposed within the housing 104 of the central lock assembly 102 and the housing 104 can be removed from the door. When the female adapter 124 is disengaged, the cross-wall 166 may provide support for the hook arm 146 and so that the second hook 158 is spaced apart from the bottom wall of the housing 144. Additionally, the safety screw 152 is transversely accessible via the transverse opening 114 of the housing 104 for access to the coupler 120. In the example, the base wall 155 of the housing 144 is opposite the transverse opening 114 to facilitate access to the coupler 120. As such, the hook arm 146 may face the transverse opening 114

To couple the coupler 120 back together, the decoupling steps are reversed with the male adapter 122 being axially inserted into the female adapter 124 such that the noses of the hooks slide past each other until engaged. The hook arm 146 is biased towards the engaged position so that once in position, the hooks are automatically engaged. Then, the safety screw 152 is used to lock the position of the hook arm 146 on the female adapter 124. As illustrated in FIG. 13, the female adapter 124 can be disposed completely within the housing 104 and within the longitudinal face while still enabling operation of the coupler 120 described herein.

In an aspect, one method to disconnect the drive rods 118 from the slider bar 110 includes removing a faceplate (not shown) of the housing 104 of the central lock assembly 102. This allows access to the openings of the housing 104 and to the coupler 120 no matter what position the coupler 120 is in and relative to the housing 104. The remote locks are extended and constrained at the head and sill of the door. The safety screw 152 on the female adapter 124 is loosened and the hook arm 146 is depressed into the housing 144 of the female adapter until the hooks clear each other. While depressing the hook arm 146, the slider bar 110 is retracted slightly to disconnect the male adapter 122 from the female adapter 124. This process can be repeated for the other coupler.

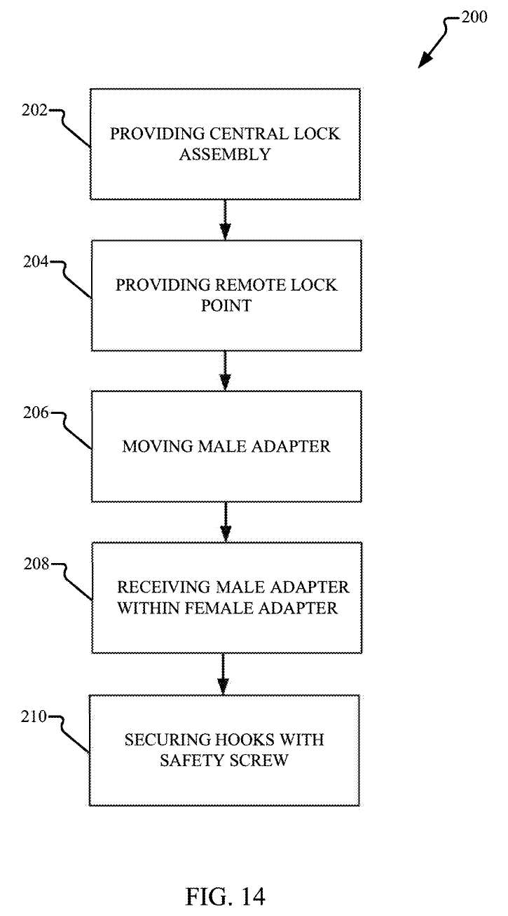

FIG. 14 is a flowchart illustrating an exemplary method 200 of assembling a multipoint lock system. The exemplary methods and operations can be implemented or performed by the multipoint lock system and the coupler assembly described herein (e.g., the multipoint lock system 100 and the coupler 120, 300 shown in FIGS. 1-13 and 15-16). The method 200 begins with providing a central lock assembly (operation 202). The central lock assembly includes a slider bar disposed at least partially within a housing and configured to slide along a longitudinal axis. The slider bar may be any type of longitudinally sliding component of the central lock assembly as required or desired. A female adapter is coupled to the slider bar and includes a U-shaped housing and a first hook pivotably mounted to the U-shaped housing. The method 200 also includes providing a remote lock point (operation 204). The remote lock point can include a drive rod also movable along the longitudinal axis and coupled to a male adapter having a second hook. In examples, the central lock assembly and/or the remote lock point may be mortised within a door edge of a door such that the assembly steps are performed on the door

The second hook of the male adapter with the drive rod is moved along the longitudinal axis toward the first hook of the female adapter (operation 206). Then the second hook of the male adapter is received within a distal end of the female adapter such that the second hook is engaged with the first hook of the female adapter (operation 208). When the second hook of the male adapter is received by the first hook of the female adapter, a biased position of the first hook is overcome. In an example, the female adapter may be disposed completely within the housing of the central lock assembly when receiving the second hook of the male adapter. Once the hooks are engaged, a safety screw can be used to secure the engagement between the hooks (operation 210).

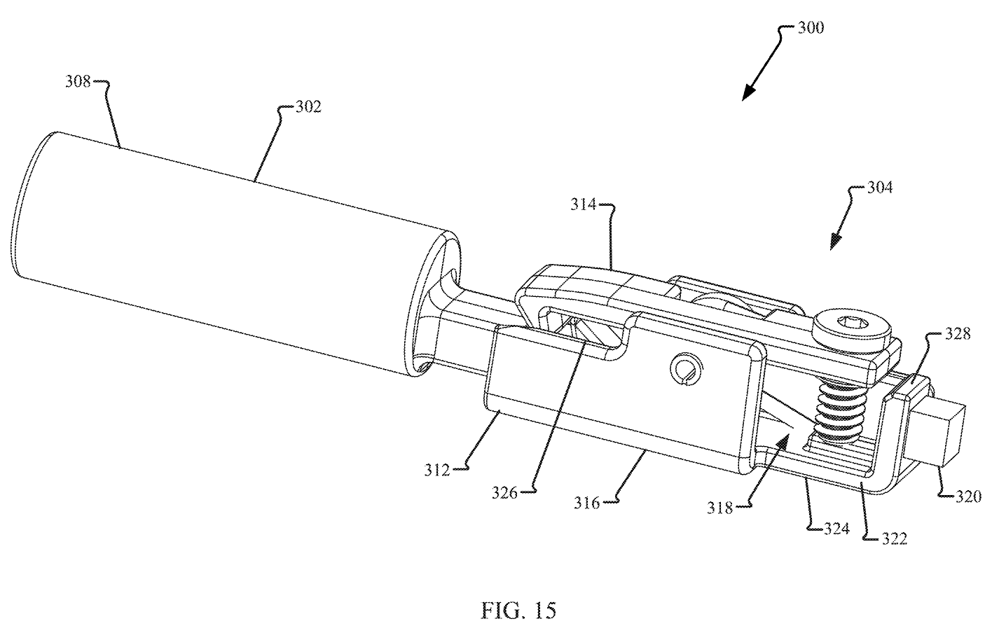

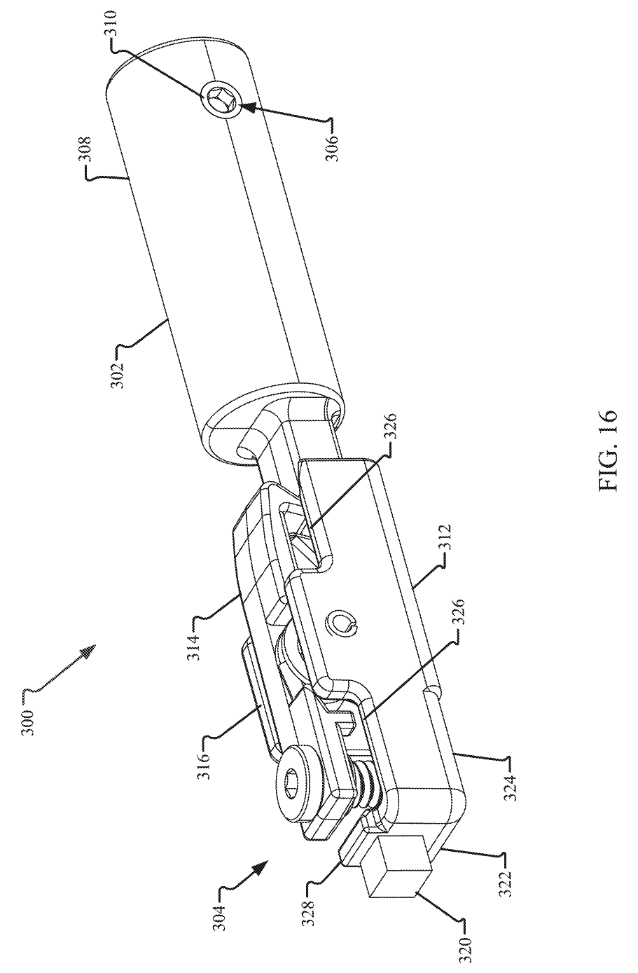

FIGS. 15 and 16 are perspective views of another exemplary coupler 300. Referring concurrently to FIGS. 15 and 16, the coupler 300 includes a male adapter 302 and a female adapter 304 that operates the same as the coupler 120 described above. Accordingly, the features that are the same are not further described below. In this example, the male adapter 302 includes a hole 306 defined in a cylindrical portion 308. A set screw 310 is provided at the hole 306 and facilitates securing the drive rod to the male adapter 302. Additionally, the male adapter 302 is allowed to be more easily clocked in the desired direction when installing the muti-point lock system into the door

The female adapter 304 includes a housing 312 and a hook arm 314. One sidewall 316 of the housing 312 includes an opening 318 disposed at the end having a projection 320. Additionally, a base wall 322 of the housing 312 has a reduced thickness 324 proximate the end having the projection 320. These modifications to the housing 312 facilitate operational clearance within certain gearbox configurations. Additionally, or alternatively, interior chamfers 326 are included within the housing 312 that facilitate coupling fit with the male adapter 302. The housing 312 can also include a lip 328 proximate the projection 320 that improves attachment to the slider bar and an increased size of the projection 320.

As described above, the coupler includes a female adapter having a housing, a spring-loaded pivoting hook arm, and a safety screw, and a male adapter that is a threaded rod adapter link. The female adapter is attached to the main and reversing slider bars of the central lock assembly, while threaded rods of remote lock points are attached to the male adapter. The hook arm pivots about a pivot point on the housing and is tensioned by a torsion spring. There is a mating beveled hook on the male adapter that, once axially aligned and pushed into the housing of the female adapter, will lock onto the hook arm and connect the threaded rods to the slider bar. The safety screw is then tightened to reduce or prevent the hooks from separating.

The materials utilized in the manufacture of the multipoint lock system described herein may be those typically utilized for door hardware, e.g., zinc, steel, aluminum, brass, stainless steel, etc. Molded plastics, such as PVC, polyethylene, etc., may be utilized for the various components. Material selection for most of the components may be based on the proposed use of the multipoint lock system. Appropriate materials may be selected for components used on particularly heavy panels, as well as on components subject to certain environmental conditions (e.g., moisture, corrosive atmospheres, etc

While there have been described herein what are to be considered exemplary and preferred examples of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claim is:

1. A coupler for a multipoint lock system comprising:
a male adapter having a first end having a first hook and an opposite second end configured to attach to a drive rod of a remote lock point of the multipoint lock system; and
a female adapter comprising:
a U-shaped housing with a first end configured to attach to a slider bar of a central lock assembly of the multipoint lock system and an opposite second end configured to receive the first hook of the male adapter;
a hook arm pivotably mounted to the U-shaped housing, the hook arm including a second hook disposed at the second end of the U-shaped housing;
a safety screw mounted to the hook arm and positioned at the first end of the U-shaped housing; and
a biasing member biasing a pivoting position of the hook arm, wherein upon axial insertion of the male adapter into the female adapter, the first and second hooks engage and the safety screw is configured to secure the pivoting position of the hook arm relative to the U-shaped housing, and wherein the biasing member biases the hook arm towards an engaged configuration.

2. The coupler of claim 1, wherein the second hook is disposed on one end of the hook arm and a threaded aperture for the safety screw is disposed on an opposite end of the hook arm, and wherein the hook arm is coupled to a pivot pin extending across the U-shaped housing, the pivot pin disposed between the second hook and the threaded aperture.

3. The coupler of claim 1, wherein the U-shaped housing includes a cross-wall disposed between the first and second ends of the U-shaped housing, the cross-wall defining an axial end of a receiving chamber for the first hook of the male adapter within the female adapter.

4. The coupler of claim 3, wherein the hook arm is pivotably mounted to the U-shaped housing with a pivot pin, the pivot pin disposed between the first end of the U-shaped housing and the cross-wall.

5. The coupler of claim 1, wherein the first end of the U-shaped housing includes a stop for the safety screw.

6. The coupler of claim 1, wherein a thickness of the first hook is greater than a thickness of the second hook.

7. A multipoint lock system comprising:
a central lock assembly having a deadbolt configured to extend and retract along a transverse axis relative to a housing, wherein a slider bar is disposed at least partially within the housing and configured to slide along a longitudinal axis orthogonal relative to the transverse axis;
a remote lock point operable via a drive rod, movable along the longitudinal axis, via the slider bar of the central lock assembly; and
a coupler comprising:
a first adapter having a first hook configured to couple to the drive rod of the remote lock point or the slider bar of the central lock assembly; and
a second adapter configured to couple to the other of the drive rod of the remote lock point or the slider bar of the central lock assembly, the second adapter including:
a U-shaped housing;
a second hook pivotably mounted to the U-shaped housing, wherein the second hook is biased in a direction towards a base wall of the U-shaped housing, and wherein upon axial insertion of the first hook into the U-shaped housing along the longitudinal axis, the first and second hooks engage operationally connecting the drive rod and the slider bar for movement along the longitudinal axis.

8. The multipoint lock system of claim 7, further comprising a safety screw coupled to the second adapter and locking the engagement between the first and second hooks.

9. The multipoint lock system of claim 8, wherein the housing of the central lock assembly defines at least one longitudinal axis opening and at least one transverse axis opening, and wherein the safety screw is accessible through the at least one transverse axis opening.

10. The multipoint lock system of claim 9, wherein a base of the U-shaped housing is opposite of the at least one transverse axis opening such that the second hook faces the at least one transverse axis opening.

11. The multipoint lock system of claim 7, wherein the second adapter is coupled to the slider bar of the central lock assembly, and wherein when the slider bar is disposed in a retracted position within the housing, the second adapter is completely disposed within the housing.

12. The multipoint lock system of claim 7, wherein the first adapter is coupled to the drive rod of the remote lock point.

13. The multipoint lock system of claim 12, wherein the first hook is radially offset from a center axis of a cylindrical portion configured to couple to the drive rod.

14. The multipoint lock system of claim 7, wherein the U-shaped housing includes a first end and an opposite second end, a cross-wall is disposed between the first and second ends, the cross-wall defining an axial stop for receipt of the first hook.

15. The multipoint lock system of claim 14, wherein a pivot point for the second hook is disposed between the first end of the U-shaped housing and the cross-wall.

16. The multipoint lock system of claim 7, wherein the first hook has a thickness that is greater than a thickness of the second hook.

17. The multipoint lock system of claim 7, wherein the first hook includes a rounded nose, an oblique surface extending from the rounded nose, and a planar return extending in the transverse axis direction, and wherein adjacent to the planar return, the first hook includes a recess configured to engage with a portion of the second hook.

18. A method of assembling a multipoint lock system comprising:
providing a central lock assembly having a slider bar disposed at least partially within a housing and configured to slide along a longitudinal axis, the slider bar coupled to a female adapter having a U-shaped housing and a first hook pivotably mounted to the U-shaped housing;
providing a remote lock point having a drive rod movable along the longitudinal axis, the drive rod coupled to a male adapter having a second hook;
moving the second hook of the male adapter with the drive rod along the longitudinal axis;
receiving the second hook of the male adapter within a distal end of the female adapter and engaging the second hook with the first hook of the female adapter, wherein receiving the second hook of the male adapter overcomes a biased position of the first hook; and
securing the engagement between the first and second hooks with a safety screw.

19. The method of claim 18, wherein the female adapter is disposed completely within the housing of the central lock assembly when receiving the male adapter.

20. The method of claim 18, wherein the central lock assembly and the remote lock point are mortised within an edge of a door.
